(19) United States
(12) Patent Application Publication
(10) Pub. No.: US 2009/0265633 A1
(43) Pub. Date: Oct. 22, 2009

(54) Network gateway for a vehicle

(75) Inventors: Ji Hyun Lim, Gyeonggi-do (KR); Nam Kwon Jung, Gyeonggi-do (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 12/220,929

(22) Filed: Jul. 30, 2008

(30) Foreign Application Priority Data
Apr. 22, 2008 (KR) 10-2008-0037378

(51) Int. Cl. G06F 3/14

(52) U.S. Cl. 715/733

(57) ABSTRACT

The present invention relates to the network gateway for the vehicle sharing the contents between all display units of an inside-vehicle. For this, the invention includes an interface connecter which is connected respectively to at least one or more display units that receive a user command and display the process result for the user command; and a controller which shares a contents by transmitting the contents from a specific display unit to another display unit in case it is commanded to perform the contents sharing from the specific display unit through the interface connecter.

### CROSS-REFERENCE TO RELATED APPLICATION

This application claims under 35 U.S.C. §119(a) the benefit of Korean Patent Application No. 10-2008-37378 filed Apr. 22, 2008, the entire contents of which are incorporated herein by reference.

### BACKGROUND

The present invention relates to a network gateway for a vehicle, and more particularly, to a technology sharing the contents between all displays in the inside of a vehicle.

Recently, the number of vehicles containing a telematics module have increased in order to improve the stability of a vehicle or the convenience of a driver while enhancing the quality of the vehicle. The telematics module can include a mobile communications connection module (for example, the Code Division Multiple Access CDMA module) for connecting to the mobile communications network, which enables the vehicle to connect to the wireless Internet (hereinafter, “Internet”) through a mobile communications network. By using the telematics module, a driver can connect to the Internet while inside the vehicle to transceive an e-mail or search various information.

The telematics module can report the condition of the vehicle to the driver when vehicle failure is detected after diagnosing the vehicle at a remote site through a mobile communications network, and can inform the driver of follow-up measures for solving vehicle failure. The telematics module can provide the various information, including, but not only limited to, traffic information, living information, and also provide emergency rescue through the Internet.

Additionally, a plurality of display units have been installed inside of a vehicle as the quality of the vehicle has improved. In the inside of the vehicle, the display unit can be fixed in a given position of a dash board or in a predetermined part of a front glass so that the passenger (including a driver) of the front seat might see the display unit, or alternatively it can be installed at the backside of the front seat, the center console, or the roof of the vehicle so that the passenger of the rear seat might see the display unit.

Each display can be independently operated, and also can be dependently operated on a specific display unit. The display units that are controlled by the one particular display unit have to be connected to that particular display unit in order that a plurality of display units are dependently operated on a particular display unit. Accordingly, the physical connection between the display units can be difficult as the number of display units increases.

Thus, contents sharing between the display units of only a certain number or less becomes possible, and the contents sharing of all display units of the inside of the vehicles of any desired number is not realized.

The above information disclosed in this the Background section is only for enhancement of understanding of the background of the invention and therefore it may contain information that does not form the prior art that is already known in this country to a person of ordinary skill in the art.

### SUMMARY OF THE INVENTION

In one aspect, the invention features a network gateway for a vehicle including an interface connecter which is connected respectively to at least one or more display units that receive a user command and display a process result for the user command; and a controller which shares contents by transmitting the contents from a specific display unit to another display unit in case it is commanded through the interface connecter to share the contents from the specific display unit.

In accordance with one embodiment of the invention, the network gateway for a vehicle further includes a wireless LAN connecter which is preferably connected to a mobile device equipped with a wireless LAN, wherein the controller shares the contents by suitably transmitting a encoded and compressed data corresponding to the contents which is transmitted from the mobile device to a display unit which is designated by the mobile device in case it is commanded through the wireless LAN connecter to share the contents from the mobile device.

The controller preferably shares the contents by encoding and compressing data corresponding to the contents which is transmitted from a display unit which suitably requests the content sharing and transmitting to the mobile device in case it is commanded to perform the contents sharing with the mobile device from a specific display through the interface connecter. Preferably, a printed circuit board in which the interface connecter and the controller are designed is installed in the inside of the user interface. Preferably, a printed circuit board in which the interface connecter, the controller, and the wireless LAN connecter are designed is installed in the inside of the user interface.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a block diagram of the system which applies a network gateway of a vehicle according to an embodiment of the present invention.

FIG. 2 is a detailed block diagram of the network gateway illustrated in FIG. 1.

FIG. 3 is a flowchart for illustrating the operation of a network gateway for a vehicle according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

As described herein, the present invention includes a network gateway for a vehicle, comprising an interface connecter and a controller which shares contents. In one embodiment, the interface connector is connected to at least one or more display units that receive a user command and display a process result for the user command. In another embodiment, the controller shares contents by transmitting the contents from a specific display unit to another display unit. In a related embodiment, the controller is commanded through the interface connecter to share the contents from the specific display unit.

In a further related embodiment, the network gateway for a vehicle further comprises a wireless LAN connecter which is connected to a mobile device equipped with a wireless LAN, wherein the controller shares the contents by transmitting a encoded and compressed data corresponding to the contents which is transmitted from the mobile device to a display unit which is designated by the mobile device in case it is commanded through the wireless LAN connecter to share the contents from the mobile device.

The invention also includes a motor vehicle comprising the network gateway as described herein.

Hereinafter, an embodiment of the present invention will be illustrated with reference to the attached exemplary drawings.

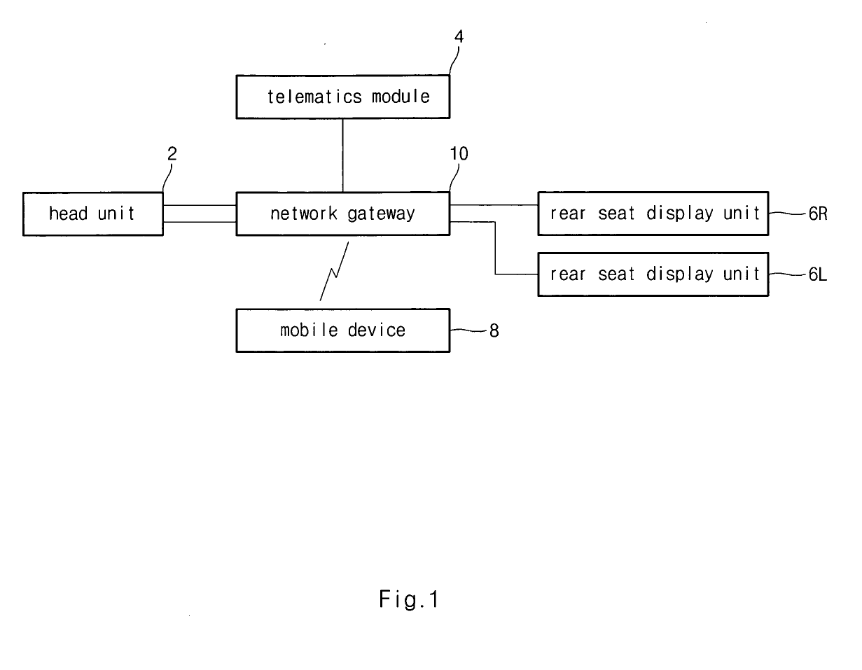

FIG. 1 is an exemplary block diagram of the system which applies a network gateway of a vehicle according to an embodiment of the present invention.

As shown in FIG. 1, the network gateway for a vehicle according to a preferred embodiment of the present invention is connected to a head unit 2, a rear seat display unit 6R, 6L, and a mobile device 8. The head unit 2 is a suitable user interface which receives a command from a user and indicates the result of performing the received command. In one embodiment of the present invention, the head unit 2 suitably corresponds to a display unit which is preferably provided for the passenger of a front seat.

In another preferred embodiment of the present invention, it is preferable that the head unit 2 includes a suitable menu or a suitable button for inputting the suitable command relating to the contents sharing. It is preferable in certain examples that the head unit 2 is implemented with a touch panel. In certain embodiments, the rear seat display unit 6R, 6L are display units which are preferably provided for the rear seat passenger of the vehicle. The rear seat display unit 6R, 6L can preferably perform the same function as the head unit 2. The rear seat display unit 6R, RL may suitably include a menu or a button for inputting the command relating to the contents sharing. And, in another preferred embodiment of the present invention, the head unit 2 can be implemented with a suitable touch panel.

In another embodiment of the present invention, the rear seat display unit 6R, 6L may include all suitable display devices installed at arbitrary locations of the inside of the vehicle such as a suitable monitor installed at, for example but not limited to, the backside surface of the front seat, a center console, or a vehicle roof.

The network gateway 10 is suitably connected to the mobile device 8 with the wireless LAN (for example, the Wireless Internet Platform for Interoperability WIPI, and so on), and preferably connected to the head unit 2, the telematics module 4, and the rear seat display unit 6R, 6L with a wire. When the contents sharing of the mobile device 8 is suitably requested from, for example, the head unit 2, the rear seat display unit 6R, 6L, or the mobile device 8, the network gateway 10 provides the contents for sharing to the head unit 2, or to the rear seat display unit 6R, 6L. The mobile device which is applicable in the present invention preferably includes all of a notebook, a laptop, a portable multimedia player PMP, a portable game console, and a hand-held music player (IPod), however any suitable mobile device may be used.

In embodiment exemplified in FIG. 1, the head unit 2 and the rear seat display unit 6R, 6L are separately illustrated. In another exemplary embodiment, the user interface in which a user command is preferably inputted and the processed result of the user command is indicated is preferably synthetically designed or may be suitably implemented with one or more display units.

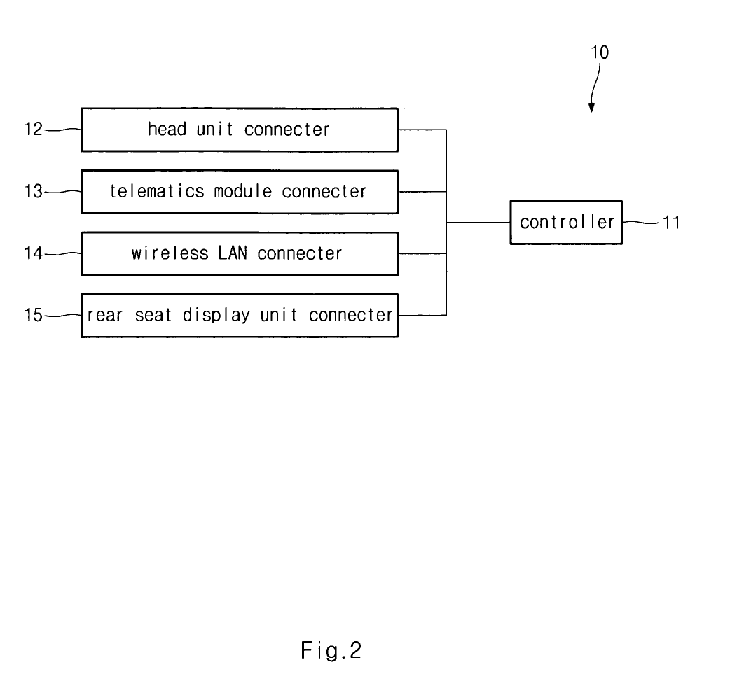

FIG. 2 is an exemplary detailed block diagram of the network gateway illustrated in FIG. 1.

As shown in FIG. 2, the network gateway 10 preferably includes a head unit connecter 12, a telematics module connecter 13, a wireless LAN connecter 14, a rear seat display unit connecter 15, and a controller 11.

The head unit connecter 12 is suitably connected to the head unit 2 through a wire, and receives a command signal and an image signal transmitted from the head unit 2 with the low voltage differential signaling LVDS mode to transmit to the controller 11. In other embodiments, it also preferably transmits the contents transmitted from the head unit 2 under the control of the controller 11 to the wireless LAN connecter 14 or the rear seat display unit connecter 15, thereby, outputting the contents to the mobile device 8 or the rear seat display unit 6R, 6L. In addition, the head unit connecter 12 preferably includes a communications line that transmits an encoded image data which is transmitted from the wireless LAN connecter 14 to the head unit 2.

In another embodiment of the present invention, the head unit connecter 12 can receive the command signal for contents sharing from the head unit 2. The telematics module connecter 13 is preferably connected to the telematics module 4 and a USB line to communicate by the USB signaling mode (for example, USB 2.0), requesting the Internet access to the telematics module 4 under the control of the controller 11, and providing the Internet data transmitted from the telematics module 4 to the wireless LAN connecter 14. The wireless LAN connecter 14 is preferably connected to the mobile device 8 with the wireless LAN (for example, the WiFi 802.11b protocol), so that the mobile device 8 can preferably share the contents with other display units under the control of the controller 11. An antenna for performing the wireless LAN can be installed in the printed circuit board PCB with the embedded type.

The rear seat display unit connecter 15 is connected to the rear seat display unit 6R, 6L with a wire (for example, the giga bit Ethernet). In another embodiment of the present invention, the rear seat display unit connecter 15 preferably receives the command signal and the image signal transmitted from the rear seat display unit 6R, 6L to transmit to the controller 11.

In a further preferred embodiment of the present invention, the rear seat display unit 6R, 6L can be implemented with a touch panel. In this case, the rear seat display unit connecter 15 can suitably receive the command signal and the image signal transmitted from the rear seat display unit 6R, 6L with the low voltage differential signaling mode. The controller 11 suitably controls the head unit connecter 12, the wireless LAN connecter 14, and the rear seat display unit connecter 15 based on the command suitably inputted from the head unit connecter 12, the wireless LAN connecter 14 or the rear seat display unit 6R, 6L, so that the contents sharing of the head unit 2, the rear seat display unit 6R, 6L, or the mobile device 8 may be suitably performed.

In another embodiment of the present invention, the printed circuit board PCB corresponding to the network gateway 10 is installed at the internal space of the head unit 2 or the rear seat display unit 6R, 6L, so that it can be suitably manufactured as a single body with the head unit 2 or with the rear seat display unit 6R, 6L.

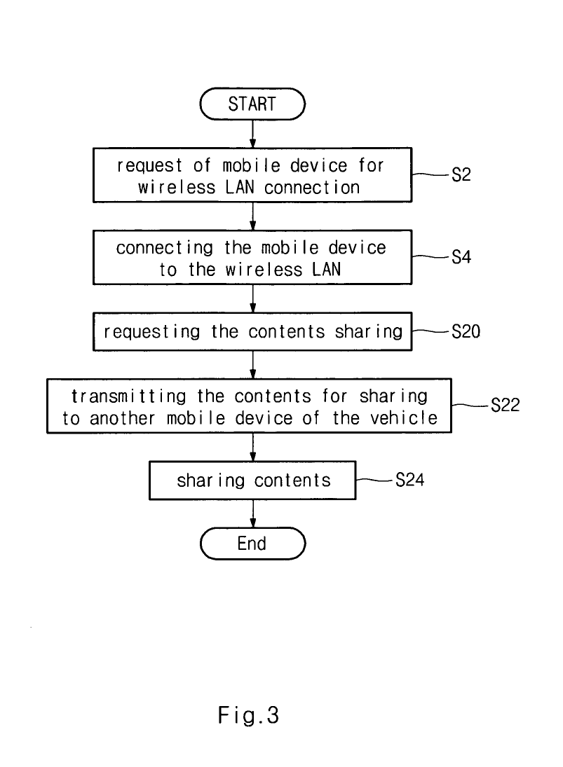

The operation of the network gateway for a vehicle according to a prefered embodiment of the present invention will be illustrated in detail with reference to the attached flowchart illustrated in FIG. 3. In the exemplary case the wireless LAN connection is requested from the mobile device 8 (S2), the controller 11 suitably assigns the radio channel to the mobile device 8 through the wireless LAN connecter 14 and connects the mobile device 8 to the wireless LAN (S4). When the wireless LAN is suitably connected through S2 and S4, in case the command according to the contents sharing is inputted from the head unit 2 through the head unit connecter 12 (S20), the network gateway preferably transmits the contents for sharing to a designated terminal through the head unit 2 (S22).

For example, when it is preferably commanded through the head unit connecter 12 to share the contents which is outputted on the head unit 2 with the rear seat display unit 6R, 6L, the contents which is preferably outputted on the head unit 2 and simultaneously transmitted from the head unit 2 to the head unit connecter 12 with the LVDS signal type is preferably transmitted to the rear seat display unit connecter 15, so that the contents is played through the rear seat display unit 6L, 6R. The contents preferably outputted on the head unit 2 according to the selection of a user is preferably transmitted to the mobile device 8 to perform the contents sharing. Accordingly, it is preferable that the wireless LAN connecter 14 compresses the received image signal after encoding under the control of the controller 11 to transmit to the mobile device 8.

In certain preferred embodiments, the head unit connecter 12 is ordered to share the contents that are outputted on the mobile device 8 which is preferably connected to the wireless LAN with the head unit 2 or the rear seat display unit 6R, 6L, the contents which is outputted on the mobile device 8 and simultaneously transmitted from the mobile device 8 to the wireless LAN connecter 14 is transmitted to the head unit connecter 12 or the rear seat display unit connecter 15, so that the contents corresponding to the contents data is preferably played through the head unit 2 or the rear seat display unit 6L, 6R.

Preferably, in case the contents data is an image data, it is suitably transmitted with being encoded and compressed from the mobile device 8, preferably to the head unit 2 or the rear seat display unit 6L, 6R where receiving the image data decodes the encoded image data, so that the image corresponding to the image data is suitably displayed.

According to the above description, the content sharing of the head unit 2, the rear seat display unit 6L, 6R, and the mobile device 8 can be performed (S24). In preferred embodiments of the present invention, it is commanded through the head unit 2 or the mobile device 8 to perform the contents sharing. However, in other embodiments, it may be suitably commanded through the rear seat display unit 6L, 6R to perform the contents sharing. Through the content sharing process described in detail, the music, the image, the scheduling, the address book corresponding to a user data which is managed through the head unit 2 or the mobile device 8 is suitably outputted to the rear seat display unit 6R, 6L, through the network gateway 10, so that the contents sharing of a vehicle passenger is able to be readily performed.

As described above, although all displays installed at the inside of the vehicle are not directly physically connected, each display is suitably connected to the gateway for a vehicle, thereby, the network gateway for a vehicle according to an embodiment of the present invention is able to own the contents transmitted from other display in common. Therefore, although all displays suitably installed at the inside of the vehicle are not directly physically connected, the present invention preferably has an effect that the all display units can hold the contents in common.

What is claimed is:

1. A network gateway for a vehicle, comprising:
an interface connecter which is connected respectively to at least one or more display units that receive a user command and display a process result for the user command; and
a controller which shares contents by transmitting the contents from a specific display unit to another display unit in case it is commanded through the interface connecter to share the contents from the specific display unit.

2. The network gateway for a vehicle of claim 1, further comprising a wireless LAN connecter which is connected to a mobile device equipped with a wireless LAN,
wherein the controller shares the contents by transmitting a encoded and compressed data corresponding to the contents which is transmitted from the mobile device to a display unit which is designated by the mobile device in case it is commanded through the wireless LAN connecter to share the contents from the mobile device.

3. The network gateway for a vehicle of claim 2, wherein the controller shares the contents by encoding and compressing a data corresponding to the contents which is transmitted from a display unit which requests the content sharing and transmitting to the mobile device in case it is commanded to perform the contents sharing with the mobile device from a specific display through the interface connecter.

4. The network gateway for a vehicle of claim 1, wherein a printed circuit board in which the interface connecter and the controller are designed is installed in the inside of the user interface.

5. The network gateway for a vehicle of claim 2, wherein a printed circuit board in which the interface connecter, the controller, and the wireless LAN connecter are designed is installed in the inside of the user interface.

6. A network gateway for a vehicle, comprising:
an interface connecter; and
a controller which shares contents.

7. The network gateway of claim 6, wherein the interface connector is connected to at least one or more display units that receive a user command and display a process result for the user command.

8. The network gateway of claim 6, wherein the controller shares contents by transmitting the contents from a specific display unit to another display unit.

9. The network gateway of claim 8, wherein the controller is commanded through the interface connecter to share the contents from the specific display unit.

10. The network gateway for a vehicle of claim 6, further comprising a wireless LAN connecter which is connected to a mobile device equipped with a wireless LAN,
wherein the controller shares the contents by transmitting a encoded and compressed data corresponding to the contents which is transmitted from the mobile device to a display unit which is designated by the mobile device in case it is commanded through the wireless LAN connecter to share the contents from the mobile device.

11. A motor vehicle comprising the network gateway of claim 1.

12. A motor vehicle comprising the network gateway of claim 6.
